(19) United States
(12) Patent Application Publication
(10) Pub. No.: US 2006/0193414 A1
(43) Pub. Date: Aug. 31, 2006

(54) Synchronization and data recovery device

(76) Inventors: Peter Gregorius, Munchen (DE); Paul Wallner, Prien (DE)

Correspondence Address: EDELL, SHAPIRO & FINNAN, LLC, 1901 RESEARCH BOULEVARD, SUITE 400, ROCKVILLE, MD, 20850, US

(21) Appl. No.: 11/345,668

(22) Filed: Feb. 2, 2006

(30) Foreign Application Priority Data
Feb. 4, 2005 (DE) 10 2005 005 326.2

(51) Int. Cl. H04L 7/00

(52) U.S. Cl. 375/355

(57) ABSTRACT

A synchronization and data recovery device (SuD) for clock-synchronized recovery of data bits in a data stream is provided, which is particularly suitable for improved backward identification of data in serial receiver interfaces of high-speed semiconductor memory modules and/or memory controller modules with a low data density. The SuD includes a sampling unit, a data adjustment unit, a digital monitoring unit, a phase lock detector unit, a phase generator, an FIR low-pass filter and a data recovery decision unit. After synchronization of the values that have been sampled by the sampling unit in the data adjustment unit, these values are filtered in the FIR low-pass filter unit, which indicates a greater tolerance with respect to fluctuations in the ideal sampling time, in that it uses sample values of the previous symbol and of the subsequent symbol in addition to the sample values of the symbol to be identified.

### CROSS REFERENCE TO RELATED APPLICATIONS

This application claims priority under 35 USC §119 to German Application No. DE 10 2005 005 326.2, filed on Feb. 4, 2005, and titled “Synchronization and Data Recovery Device,” the entire contents of which are hereby incorporated by reference.

### FIELD OF THE INVENTION

The invention relates to a synchronization and data recovery device for clock-synchronized recovery of data bits in a data stream, in particular in a receiver interface circuit in high-speed semiconductor memory and/or memory controller modules.

### BACKGROUND

Given that the data rates per physical interface (I/O interface) will rise in future memory modules and/or memory controller modules, optimization of the sampling time for sampling of data, control and address signals will be required in systems in which the variances within the transmission channel lead to delay time differences which are greater than half the symbol duration.

In the case of the conventional technique, “Timing Recovery”, the optimum sampling time for the signal (referred to herein as the data signal) is locked in via a phase estimation method. In previous DRAM modules, techniques such as these have been unusual, and clock-synchronous interfaces were used instead. However, they are subject to the fundamental precondition that the delay times are determined between a clock and/or sampling burst. The remaining variances in the time relationship between the data signal and the sampling clock are virtually negligible when using the clock-synchronous method.

### SUMMARY OF THE INVENTION

The present invention provides a simple synchronization and data recovery device which can be used advantageously in high-speed semiconductor memory and/or memory controller modules, allows symbol clock synchronization with improved data recovery, and takes account of the special features of high-speed semiconductor memory modules and/or memory controller modules, in terms of power consumption and robustness.

In accordance with the present invention, a synchronization and data recovery device (SuD) is provided for clock-synchronized recovery of data bits in a data stream, in particular in a receiver interface circuit in high-speed semiconductor and/or memory controller modules. The SuD comprises a sampling unit that is configured to sample a serial data stream which is applied to it by a plurality of sample phases, where the sample phases are produced by a phase generator that is connected to it from a reference clock that is supplied to it and to emit corresponding sample values and a clock signal derived therefrom. A data adjustment unit is connected downstream from the sampling unit and receives the sample values produced by the sampling unit and is synchronized to a clock phase of the clock signal. An FIR low-pass filter unit, which is connected downstream from the data adjustment unit, and receives from the data adjustment unit the sample values and the clock signal synchronized to it, and is weighted with filter coefficients and uses the weighted sample values and sample values of the symbol sampled immediately before this and of the symbol sampled after this in order to decide on the present symbol, and the FIR low-pass filter unit forms a data word from this. The SuD further comprises a data recovery decision unit, which receives the data word emitted from the filter unit and the synchronized clock signal, compares them with a decision threshold value, produces a recovered data bit corresponding to the comparison result, and temporarily stores this in a register stage.

According to an exemplary embodiment of the invention, the SuD also comprises a digital monitoring unit that is connected downstream from the data adjustment unit and receives the clock signal and the data-synchronized sample values from the data adjustment unit, detects the phase angle of the sample values, and accumulates a phase error.

The digital monitoring unit can include a phase lock detector unit connected downstream from it, which identifies a locked-in state of the SuD and emits a corresponding identification signal, which signals that the locked-in or synchronized state has been reached.

The phase generator may include a DLL circuit, but is preferably in the form of a phase interpolation circuit.

In a preferred exemplary embodiment, the FIR low-pass filter unit includes a plurality of register stages with a register width which is dependent on the bus width and in each of which the even-numbered and the odd-numbered component of the sample values are temporarily stored in synchronism with the clock signal, and includes a weighting device in which the data which has been temporarily stored in the register stages is weighted with the filter coefficients of the FIR low-pass filter.

The data recovery decision unit can also be provided with hysteresis, and the decision threshold value of the data recovery decision unit is programmable in accordance with averaging of the energy in the sample, with this averaging process being carried out by the FIR low-pass filter unit.

The above and still further objects, features and advantages of the present invention will become apparent upon consideration of the following detailed description of specific embodiments thereof, particularly when taken in conjunction with the accompanying drawings wherein like reference numerals in the various figures are utilized to designate like components.

### BRIEF DESCRIPTION OF THE DRAWINGS

FIG. 1 schematically depicts a functional block diagram of a synchronization and data recovery device in accordance with present invention.

FIG. 2 schematically depicts the way in which a serial data stream which is applied to the input side of the device is sampled, in which the sampling times correspond to the locked-in state.

FIG. 3 schematically depicts a signal timing diagram, which illustrates the synchronization of the values sampled in the sampling unit to a clock phase.

FIG. 4 is a graph showing the function of the FIR low-pass filter unit, which uses redundant sample values for symbol decision-making (i.e., uses the sample values of the previous symbol and of the subsequent symbol in addition to the sample values of the symbol to be identified).

FIG. 5A is a graph showing the impulse response of the FIR low-pass filter unit, with the amplitudes of the dirac impulses corresponding to the filter coefficients of the FIR low-pass filter unit.

FIG. 5B is a graph showing the amplitude frequency response of the FIR low-pass filter unit.

FIG. 5C is a graph showing the pole zero scheme for the FIR low-pass filter unit.

FIG. 6 is a graph showing the relationships when the symbol wanders out of the optimum time window to the left and to the right, and further showing a major advantage of the use of the FIR low-pass filter unit.

FIG. 7 schematically depicts an exemplary embodiment of the sampling unit in accordance with the present invention with the downstream data adjustment unit which converts the sample values to a clock plane.

FIG. 8 schematically depicts another exemplary embodiment of the FIR low-pass filter unit with the downstream data recovery decision unit, with the data stream being subdivided into an even-numbered component and an odd-numbered component, and with the temporarily stored data being compared with a decision threshold in the data recovery decision unit.

FIG. 9 schematically depicts a DRAM memory module, which illustrates the location of the synchronization and data recovery device according to the invention in the reception interface of the DRAM memory module.

### DETAILED DESCRIPTION

In accordance with the present invention, a synchronization and data recovery device (also referred to as SuD) is described with improved data recovery. The SuD according to the invention is in general suitable for serial receiver interface circuits, in particular for serial receiver interface circuits with a low data density.

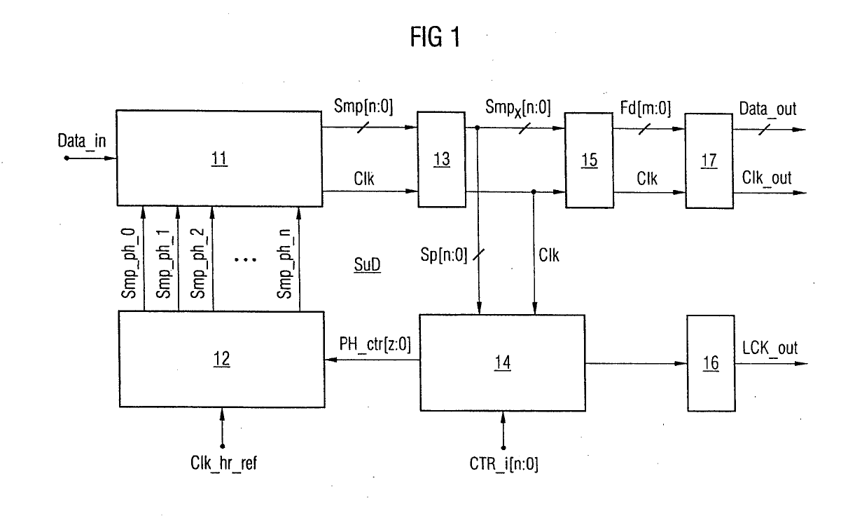

An exemplary embodiment of a synchronization and data recovery device (SuD) according to the invention is illustrated in the form of a functional block diagram in FIG. 1. The SuD includes a sampling unit 11, an associated phase generator 12 (which produces a plurality of sampling phases smp_ph_x on the basis of a reference clock clk_hr_ref derived from a system clock at twice the frequency), a data adjustment unit 13 connected downstream from the sampling unit 11, an FIR low-pass filter unit 15 connected downstream from the data adjustment unit 13, and a recovery decision unit 17 connected downstream from the FIR low-pass filter unit 15. The SuD further includes a digital monitoring unit 14 connected downstream from the data adjustment unit 13 and including a loop filter with an integrator whose coefficients can be programmed with the signal ctr_i[n:0]), and also a phase lock detector unit 16 which is connected downstream from the digital monitoring unit 14 and emits an identification signal LCK_out which supplies a message about the locked-in state of the SuD.

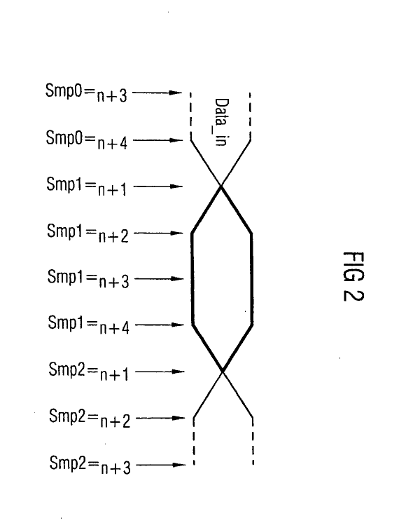

The sampling unit 11 samples a serial data stream data_in on the input side, as illustrated in FIG. 2. The sampling times depicted in FIG. 2 correspond to the locked-in state. A plurality of sampling phases smp_ph_x are produced from the reference clock clk_hr_ref for sampling purposes. In the locked-in state, the digital monitoring unit produces a signal PH_ctr[z:0] which signals this state to the phase generator 12. The phase generator 12 can be designed using known techniques, for example a DLL, but is preferably in the form of a phase interpolation device.

The digital monitoring unit 14 includes a phase detector (loop filter) and an integrator (accumulator) with programmable coefficients, which accumulates the phase error. The coefficients of the accumulator are programmed on the basis of the signal ctr_i[n:0] supplied from the outside. The fundamental circuit design of the phase detector and of the accumulator in the digital monitoring unit 14 is known per se (see, e.g., ISCAS 2001, M. Ramezani and A. Salama: “An Improved Bang-Bang Phase Detector for Clock and Data Recovery Applications”).

The phase lock detector unit 16 which is connected downstream from the digital monitoring unit 14 allows the control unit to switch off the entire system, by the production of the identification signal LCK_out which signals the locked-in state, until the system identifies a phase discrepancy that is greater than a given tolerance threshold. The control algorithm can be activated in this state. This technique allows the power consumption of the system to be optimized by temporarily switching off functional units that are not required. The expression “system” in this case means in particular the reception interface circuit of a semi-conductor memory and/or memory controller module.

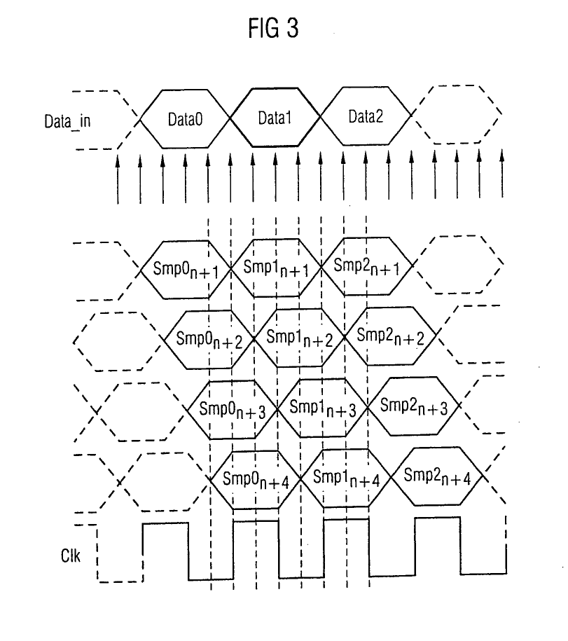

As shown in FIG. 3, the sample values are synchronized in the data adjustment unit 13 to a clock phase of the clock clk. The sampled values which have been synchronized to the clock phase are passed to the FIR low-pass filter unit 15 and to the data recovery decision unit 17, together with the clock signal clk, for further processing.

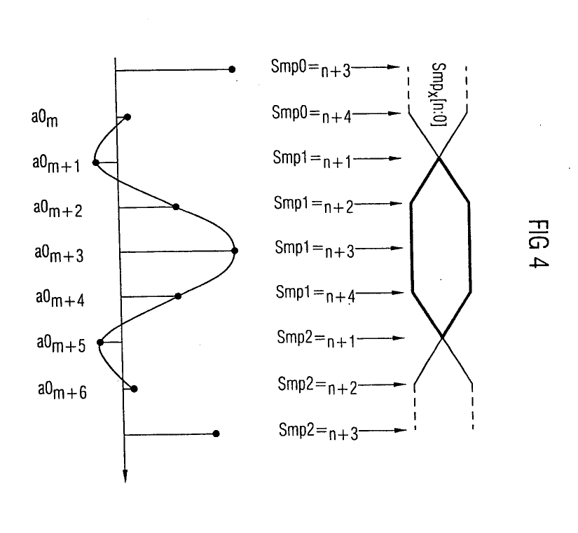

The FIR low-pass filter unit additionally uses redundant sample values for symbol decision-making as shown in FIG. 4, to be precise, in addition to the sample values of the symbol to be identified (shown by a bold line in the upper line in FIG. 4 and in FIG. 2), additionally the sample values smp0ₙ₊₃, smp0ₙ₊₄ of the immediately preceding symbol and the sample values smp2ₙ₊₂ and smp2ₙ₊₃ of the subsequent symbol. The amplitudes of the dirac pulses, as illustrated in the lower part of FIG. 4, correspond to the filter coefficients A0ₘ, A0ₘ₊₁, . . . , Aₘ₊₆ of the FIR low-pass filter unit 5.

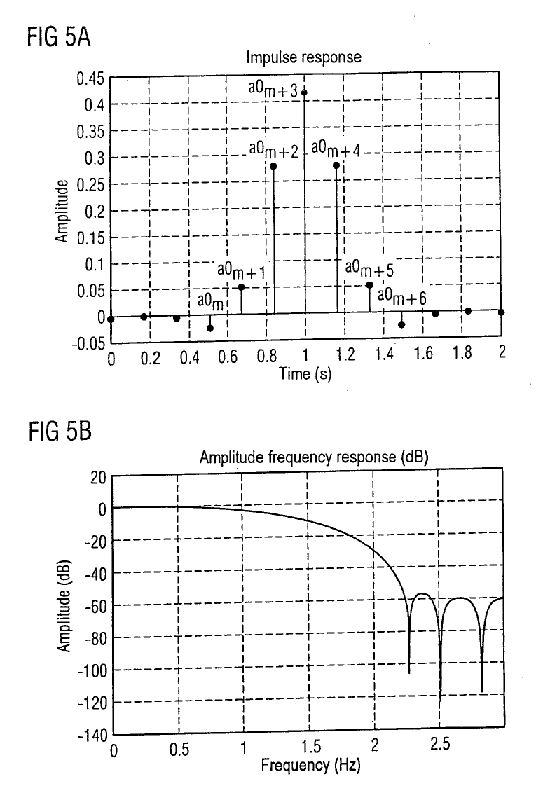

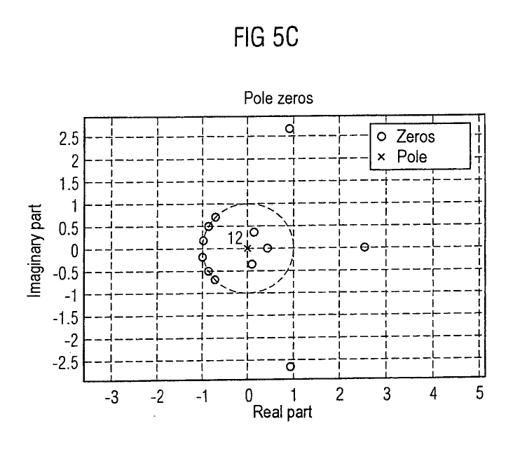

FIG. 5A shows an impulse response of the FIR low-pass filter, while FIG. 5B shows its amplitude frequency response and FIG. 5C shows the associated pole zero scheme. The low-pass filter characteristic as illustrated in FIGS. 5A-5C is, of course, only by way of example and can be matched to the respective purpose.

One advantage of the use of the FIR low-pass filter unit 15 for data recovery is the greater tolerance of the SuD to fluctuations from the ideal sampling time. Instead of having to use only the value of the supposedly optimum sampling time for data decision-making, additional sample values of the previous symbol and of the subsequent symbol are also used for data decision-making. If the symbol wanders out of the optimum time window, the system can thus compensate for fluctuations of less than half the symbol duration without any additional readjustment. No incorrect decisions are made.

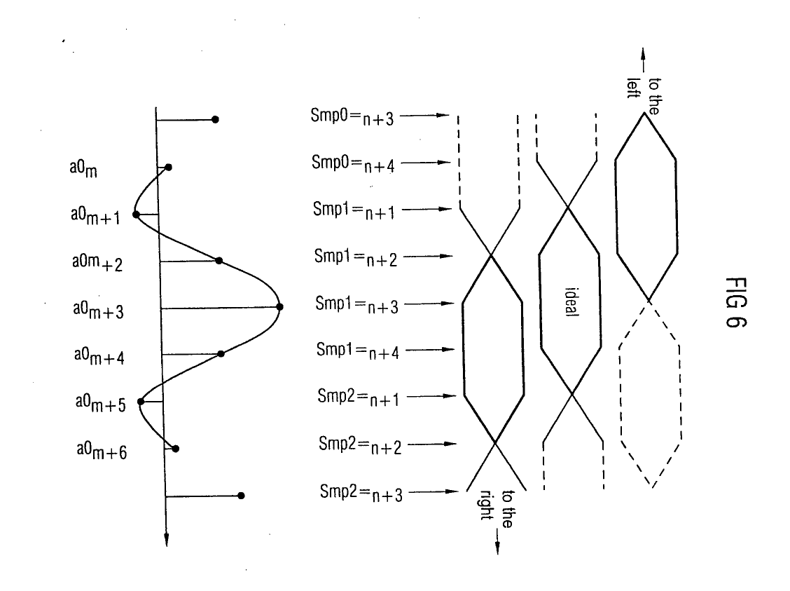

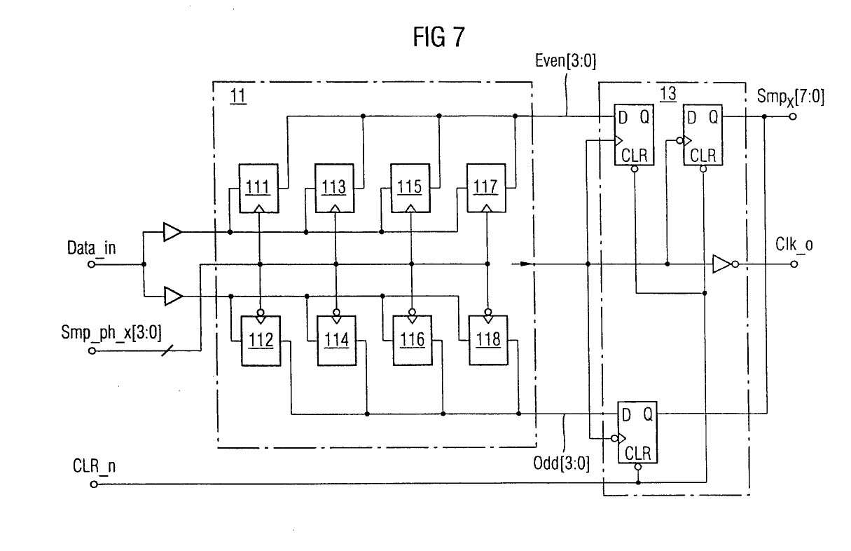

The principle is illustrated in FIG. 6. If the data eye (symbol) has moved to the left or right, then the sampling unit can no longer ideally sample the data eye. If the synchronization, that is to say the “Timing Recovery” of the clock signal clk, is not readjusted, then the previously selected optimum sampling time is now located in the flank change. However, the FIR low-pass filter unit 15 averages the energy in the sample. The decision threshold TH of the data recovery decision unit 17 which is connected downstream from the FIR low-pass filter unit 15 can be programmed as appropriate. Reliable data recovery is thus possible in a given tolerance range.

The block diagram illustrated in FIG. 7 shows one possible exemplary embodiment of the circuit arrangement for the sampling unit 11 with the downstream data adjustment unit 13. The symbols are sampled using the half-clock process on the basis of the reference clock clk_hr_ref, that is to say on the rising and falling flanks of the sampling phases. The period duration of the reference clock clk_hr_ref corresponds to twice the symbol duration. A sampling unit 11 contains two rows of data latches 111, 113, 115 and 117, as well as 112, 114, 116 and 118, and passes the sample values separately on the basis of even-numbered and odd-numbered values to the data adjustment unit 13, which converts these sample values to a clock plane. The sample values smpₓ[n:0] are passed on together with the clock clk_o to the FIR low-pass filter unit 15.

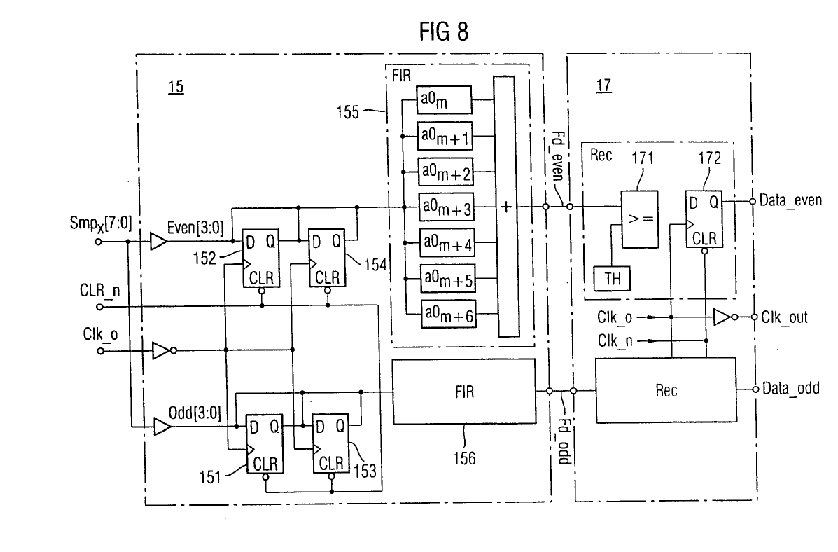

The block diagram in FIG. 8 illustrates one exemplary embodiment of the FIR low-pass filter unit 15 together with the data recovery decision unit 17. The incoming data stream, that is to say the sample values smpₓ[n:0], is temporarily stored in a plurality of registers 151-154. The register width is dependent on the bus width. In this example, the bus width is 8, so that the data stream has a width of 8 bits. This is subdivided into an even-numbered component [3:0] and an odd-numbered component [3:0] and these are in each case temporarily stored in registers with a width of four bits. The data contained in the register stages is weighted with the filter coefficients a0ₘ-a0ₘ₊₆ in the FIR filter units 155, 156 as shown in FIG. 4. The data word of the output of the FIR low-pass filter unit 15 is compared in the data recovery decision unit 17 with a decision threshold TH. The data recovery decision unit 17 for this purpose contains a comparator circuit 171 and a data register circuit 172 in the respective decision makers Rec. The recovered data bit is temporarily stored in a register stage 172 at the output of the decision maker Rec, to be precise separately on the basis of even-numbered and odd-numbered data bits data_even and data_odd. The decision maker Rec may additionally be provided with hysteresis.

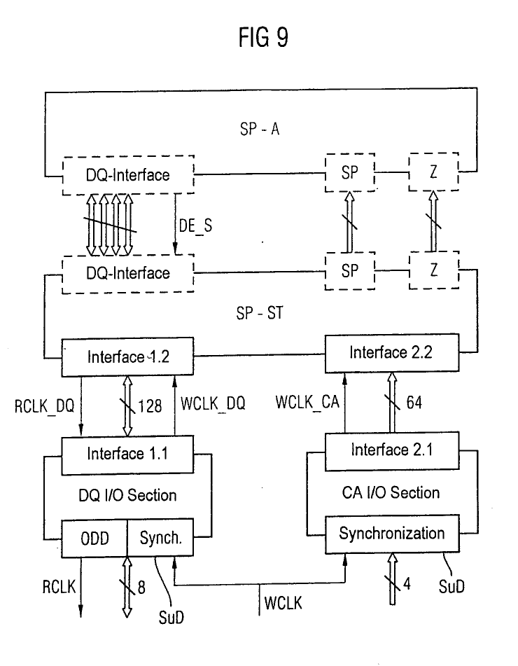

The block diagram in FIG. 9 shows the placing of the SuD of the invention in a semiconductor memory module. In this embodiment, for the sake of simplicity, the semiconductor memory module is subdivided into three functional units: the I/O section, which contains the DQ-I/O section and the CA-I/O section and, therein, the transmitter and receiver circuit sections, the monitoring unit sp_st and the data memory arrays (sp_A). The configuration of the I/O area may be both unidirectional and bidirectional. The SuD according to the invention is arranged within the I/O area in the position illustrated in FIG. 9.

While the invention has been described in detail and with reference to specific embodiments thereof, it will be apparent to one skilled in the art that various changes and modifications can be made therein without departing from the spirit and scope thereof. Accordingly, it is intended that the present invention covers the modifications and variations of this invention provided they come within the scope of the appended claims and their equivalents.

List of Reference Symbols

11 Sampling unit
12 Phase generator
13 Data adjustment unit
14 Digital monitoring unit
15 FIR low-pass filter unit
16 Phase lock unit
17 Data recovery decision unit
111-118 Latches
151-154 Register stages
155, 156 FIR filters
171 Comparator
172 Register stage
clk Synchronized clock signal
clk_hr_ref Reference clock
ctr Signal for programming of coefficients for an integrator
PH_ctr Phase centring
data_in, data0, data1, data2 Input data stream
data_out, data_even, data_odd Output data stream
smp_ph_0-smp_ph_n Sampling phase signals
smp Sample values
Fd, Fd_even, Fd_odd Filtered data
LCK_out Identification signal of the phase lock detector unit for the locked-in state
a0ₘ-aₘ₊₆ Filter coefficients
clr_n Reset signal
FIR Finite Impulse Response filter

What is claimed:

1. A synchronization and data recovery device for clock-synchronized recovery of data bits in a data stream for use in a receiver interface circuit in high-speed semiconductor memory and/or memory controller modules, the synchronization and data recovery device comprising:
a phase generator that produces a plurality of sample phases based upon a reference clock signal;
a sampling unit connected with the phase generator to receive the plurality of sample phases and configured to receive a serial data stream and to sample the serial data stream via the plurality of sample phases so as to produce sample values, the sampling unit further being configured to emit the sample values and a clock signal derived from the sample values;
a data adjustment unit connected to receive the sample values and clock signal from the sampling unit and configured to synchronize the sample values to a clock phase of the clock signal;
an FIR low-pass filter unit connected to receive from the data adjustment unit the sample values synchronized to the clock phase of the clock signal and configured to weight the sample values with filter coefficients and to use the weighted sample values and sample values of a symbol sampled before the weighted samples and of a symbol sampled after the weighted sample values in order to determine a symbol of the weighted sample values and form a data word from the symbol of the weighted sample values; and
a data recovery decision unit connected to receive the data word from the FIR low-pass filter unit and the clock signal, wherein the data recovery decision unit is configured to compare the data word and the clock signal with a decision threshold value, produce a recovered data bit based upon the comparison, and temporarily store the recovered data bit in a register stage.

2. The synchronization and data recovery device of claim 1, further comprising a digital monitoring unit connected to receive the clock signal and the synchronized sample values from the data adjustment unit, wherein the digital monitoring unit is configured to detect the phase angle of the sample values and accumulate a phase error.

3. The synchronization and data recovery device of claim 2, further comprising a phase lock detector unit connected to the digitial monitoring unit, the phase lock detector unit being configured to identify a locked-in state of the synchronization and data recovery device and to emit a corresponding identification signal when a locked-in state is identified.

4. The synchronization and data recovery device of claim 1, wherein the phase generator comprises a DLL circuit.

5. The synchronization and data recovery device of claim 1, wherein the phase generator comprises a phase interpolation circuit.

6. The synchronization and data recovery device of claim 1, wherein the FIR low-pass filter unit includes a plurality of register stages, each register stage having a register width that is dependent on the bus width and temporarily storing an even-numbered and an odd-numbered component of the sample values in synchronism with the clock signal, and a weighting device configured to weight the data that has been temporarily stored in the register stages with the filter coefficients of the FIR low-pass filter.

7. The synchronization and data recovery device of claim 1, wherein the data recovery decision unit is provided with hysteresis.

8. The synchronization and data recovery device of claim 1, wherein the decision threshold value of the data recovery decision unit is based upon the averaging of the energy in the sample values, and the averaging of the energy of the sample values is achieved by the FIR low-pass filter unit.
